(19) United States
(12) Patent Application Publication
(10) Pub. No.: US 2023/0297921 A1
(43) Pub. Date: Sep. 21, 2023

(54) APPARATUS AND METHOD WITH ARTIFICIAL INTELLIGENCE-BASED INSPECTION SCHEDULING

(71) Applicant: Elm Company, Riyadh (SA)

(72) Inventors: Mohammed Yahya Hakami, Riyadh (SA); Riad Souissi, Riyadh (SA); Arshad Ali Khan, Riyadh (SA); Noura Mohammed Algwaiz, Riyadh (SA); Waqas Syed Murtaza Bukhari, Riyadh (SA)

(73) Assignee: Elm Company, Riyadh (SA)

(21) Appl. No.: 18/084,019

(22) Filed: Dec. 19, 2022

Related U.S. Application Data
(60) Provisional application No. 63/319,949, filed on Mar. 15, 2022.

(51) Int. Cl. G06Q 10/0639; G06Q 10/0631; G06Q 10/0635

(52) U.S. Cl. CPC G06Q 10/0639; G06Q 10/06311; G06Q 10/0635

(57) ABSTRACT

An apparatus for generating an inspection schedule includes one or more processors configured to: receive one or more schedule requests comprising inspector features, establishment features, and penalty features; generate inspector information for an inspector model based on the inspector features; generate establishment information, comprising a probability of imposing a penalty on an establishment of the establishment features, for an establishment model based on the establishment features and the penalty features; and generate, for an inspector of the inspector features using a violation model, the inspection schedule based on the inspector information and the establishment information.

### CROSS-REFERENCE TO RELATED APPLICATIONS

This application claims the benefit under 35 USC 119(e) of U.S. Provisional Application No. 63/319,949 filed on Mar. 15, 2022, the entire disclosure of which is incorporated herein by reference for all purposes.

### BACKGROUND

### 1. Field

The following description relates to an inspection scheduling method and apparatus.

### 2. Description of Related Art

Inspection scheduling is a complex and resource-intensive activity that the local governments or municipalities may run to ensure businesses comply with regulations while offering various services to the residents. These businesses include but are not limited to restaurants, healthcare facilities, barber shops, cafeterias, butcher shops, etc. The regulatory inspection aims to ensure commercial business establishments comply with regulations set out by the local government while offering various services to community residents. The core purpose of these periodic inspections may be to maximize the inspectoral resource (field workers) utilization and ensure maximum compliance by accurately targeting non-compliant businesses.

The inspection process may aim to inspect business establishments by paying a visit to the businesses and ensuring compliance with the laws and regulations by checking the status of operation licenses, hygiene standards, storage and maintenance of perishable products, etc. However, the rapid urbanization and the growth of local business establishments make it a very resource-intensive and error-prone process to carry out manual inspections for the local municipalities. In addition, almost 50% of visits in certain municipalities of interest do not detect any violations. Violations are not detected because many pre-scheduled business establishments have a high compliance rate which becomes costly for the municipality to arrange a visit and pay for the inspector's time. Many Inspectors are not thorough enough to inspect an establishment which may lead to classifying the establishment as being compliant, while in reality, it should have been classified as being non-compliant. Mismatch of operation days and times of closures may lead to “missed inspection” scenarios and re-scheduling visits.

The typical systems for scheduling inspections sometimes inaccurately classify a sizeable number of businesses that are not committing violations. However, the inspection of such businesses costs the local authorities in terms of inspectors' time and other logistic expenses. In addition, only 40 to 60% of violations are genuine, requiring businesses to pay a certain amount of fines to operate violation-free. The rest of the violations are classified as awareness or warning violations.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an apparatus for generating an inspection schedule includes one or more processors configured to: receive one or more schedule requests comprising inspector features, establishment features, and penalty features; generate inspector information for an inspector model based on the inspector features; generate establishment information, comprising a probability of imposing a penalty on an establishment of the establishment features, for an establishment model based on the establishment features and the penalty features; and generate, for an inspector of the inspector features using a violation model, the inspection schedule based on the inspector information and the establishment information.

The apparatus may further include a memory configured to store instructions; wherein the one or more processors may be further configured to execute the instructions to configure the one or more processors to generate the inspector information, the establishment information, and the inspection schedule.

The inspector features may include any one or any combination of any two or more of an identity of the inspector, a number of visits the inspector is assigned to complete within a predetermined time, a number of violations issued by the inspector, a number of high risk violations issued by the inspector, a number of medium risk violations issued by the inspector, a number of low risk violations issued by the inspector, a number of approved violations issued by the inspector, a number of cancelled violations issued by the inspector, an average duration of inspection carried out by the inspector, a number of erroneous violations issued by the inspector, and a number of clean inspections issued by the inspector.

The penalty features may include any one or any combination of any two or more of a location of the establishment, a name of the establishment, an identity number of the establishment, a category of the establishment, an activity type of the establishment, a number of days since last violation of the establishment, a number of previous violations of the establishment, a number of past inspections of the establishment, a start date for a license of the establishment, an end date for the license of the establishment, and prior penalty history of the establishment.

The establishment features may include any one or any combination of any two or more of a type of the establishment, a type of license needed for the establishment, a time of operation of the establishment, previous violations issued to the establishment, a number of days since a last violation of the establishment, a number of past inspections of the establishment, a number of previous violations of the establishment, a time since last visit by the inspector to the establishment.

The inspector model may be trained based on unsupervised learning.

The one or more processors are further configured to generate a probability of non-compliance of a business regulation based on any one or any combination of any two or more of historical, geographical, and categorical features of the establishment.

The one or more processors may be further configured to generate the inspection schedule based on geographical spread between establishments of the establishment features, the time of operation of the establishment, neighborhood constraints of the establishment, and the type of the establishment.

The inspector information may include an inspector classification list including a ranking of inspectors.

In another general aspect, a method for generating an inspection schedule includes receiving one or more schedule requests comprising inspector features, establishment features, and penalty features; generating inspector information for an inspector model based on the inspector features; generating establishment information, comprising a probability of imposing a penalty on an establishment of the establishment features, for an establishment model based on the establishment features and the penalty features; and generating, for an inspector of the inspector features using a violation model, the inspection schedule based on the inspector information and the establishment information.

The method may further include generating a probability of non-compliance of a business regulation based on any one or any combination of any two or more of historical, geographical, and categorical features of the establishment.

The method may further include generating the inspection schedule based on geographical spread between establishments of the establishment features, the time of operation of the establishment, neighborhood constraints of the establishment, and the type of the establishment.

A non-transitory computer-readable storage medium may store instructions that, when executed by one or more processors, configure the one or more processors to perform any of the methods herein.

Other features and aspects will be apparent from the following detailed description, the drawings, and the claims.

### BRIEF DESCRIPTION OF THE DRAWINGS

FIG. 1 illustrates an example of system artifacts associated with data acquisition, processing, and preparation for an AI model.

FIG. 2 illustrates an example of scheduling generation process flow depicting various stages and sub-processes capturing various features in the dataset before the schedule is generated.

FIG. 3 illustrates an example of building blocks of an inspection, including types of business establishments, inspection visits, visit types, violations, and payments to municipalities for confirmed violations.

FIG. 4 illustrates an example of artifacts of the intelligent inspection scheduling process covering data acquisition, pre-processing, modeling, scheduling, and post-processing elements.

FIG. 5a illustrates an example of a configuration of gradient boosting model for finding/classifying business violations.

FIG. 5b illustrates an example of a supervisor ML XGBoost gradient descent model architecture and weighted score computation.

FIG. 5c illustrates an example of an XGBoost with TPE (Tree-structured Parzen Estimator) demonstrating the main tree node, interior (1^{st} level nodes), and leaves (last nodes).

FIG. 6 illustrates an example of a configuration of gradient boosting model for computing the probability of finding violations for business establishments.

FIG. 7 illustrates an example of a KMeans cluster for inspector performance score classification.

FIG. 8 illustrates an example of an inspector performance clustering model to distribute inspectors in a performance-based cluster for an inspection assignment.

FIG. 9 illustrates an example of data acquisition, ingestion, pre-processing, model preparation, and optimization for schedule generation and post-processing.

FIG. 10 illustrates an example of establishment and inspector models with constraints for the selection of inspectable establishments.

FIG. 11 illustrates an example of a combination of visits, licenses, and penalty payments to fine-tune the final predictive outcomes vis-à-vis business requirements through municipality trials.

FIG. 12 illustrates an example of conducting trials for the municipalities-based intelligent scheduling validation.

FIG. 13 illustrates an example of a gradient boosting model for determining the probability of finding violations for business establishments.

FIG. 14 illustrates an example of a gradient boosting model for determining the probability of finding violations for business establishments.

FIG. 15 illustrates an example of fitting an establishment model to valid visits for violation prediction.

FIG. 16 illustrates an example of using K-Means clustering to create performance-based inspector clusters and assign each inspector to a particular business for inspection based on performance.

FIG. 17 illustrates an example of combining establishment and inspector models to performance indicators to generate optimized inspection schedules.

FIG. 18 illustrates a comparison between trial and non-trial municipalities.

FIG. 19 illustrates a comparison between compliant and non-compliant visits.

FIG. 20 illustrates a comparison between trial and non-trial municipalities.

FIG. 21 illustrates an example of a user requesting an inspection schedule.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

The features of the examples described herein may be combined in various ways as will be apparent after an understanding of the disclosure of this application. Further, although the examples described herein have a variety of configurations, other configurations are possible as will be apparent after an understanding of the disclosure of this application.

The use of the term “may” herein with respect to an example or embodiment (e.g., as to what an example or embodiment may include or implement) means that at least one example or embodiment exists where such a feature is included or implemented, while all examples are not limited thereto.

Hereinafter, example embodiments will be described in detail with reference to the accompanying drawings. When describing the example embodiments with reference to the accompanying drawings, like reference numerals refer to like components and a repeated description related thereto will be omitted.

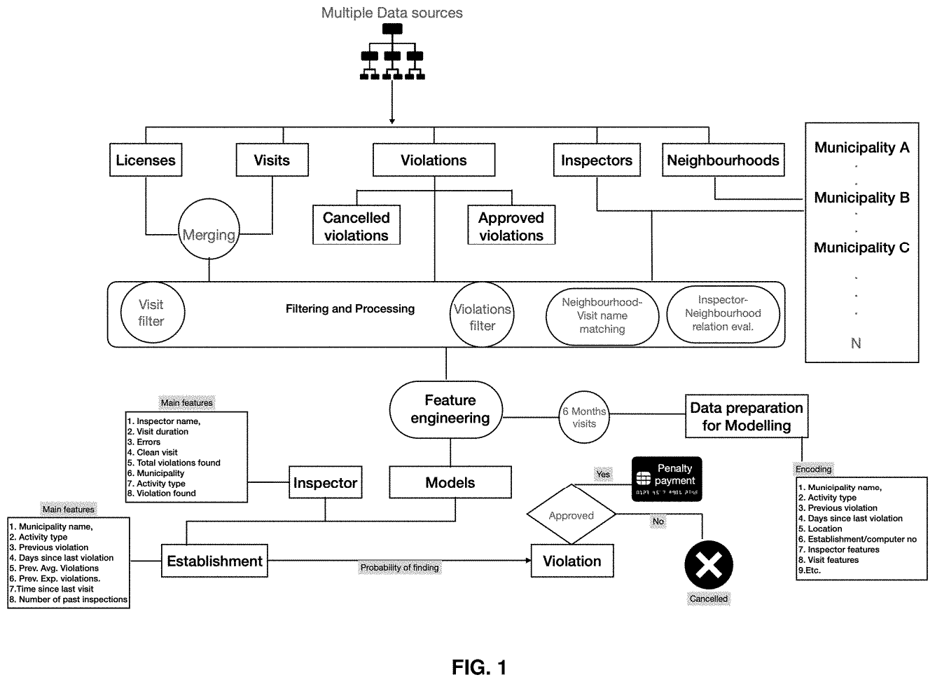

FIG. 1 illustrates an example of system artifacts associated with data acquisition, processing, and preparation for an AI model.

FIG. 1 above shows an example of the system architecture, data acquisition from multiple data sources, data processing pipeline, data preparation, and feature engineering workflow processes. In addition, the diagram shows several municipalities, the date of inspection, and other location/neighborhood components that may be considered while addressing intelligent scheduling optimization. Violations include approved violations, canceled violations, violations, objections, and pending violations.

Various components of the intelligent scheduling generation and violation identification/classification process is illustrated in FIG. 1 and further described below. The inspection scheduling system 100 may accept schedule requests as input. The schedule requests may be data from multiple different sources. For example, the input data may be provided by a user and/or input from a database. The different data types may include license data 102, visit data 103, violation data 104, inspector data 105, and neighborhood data 106.

License data 102 may refer to the different types of business licenses held by a business establishment. For example, the different business establishments may include grocery stores, restaurants, bakeries, sports shops, health labs, laundry services, and barbershops.

Visit data 103 may describe the number of visits that an inspector is assigned to complete within 48 hours. In a non-limiting example, the number of visits is 12 and 20 in another example.

Violation data 104 may include High Risk/Approved Violations, Medium Risk/Warning Violations, and Low Risk/Awareness Violations. For example, High Risk/Approved Violations may include a violation that results in a penalty. For example, Medium Risk/Warning Violations may include a business owner getting a warning without a penalty, and if the violation occurs again, it would be recorded as a high-risk violation, and the business owner may be penalized. For example, Medium Risk/Warning Violations may include violations where no penalty is needed. For example, the penalty for the violation may vary depending on the type of violation. For example, the penalty amount may vary from a few hundred dollars to a few thousand dollars.

In an example, there may be many municipalities, and some of the rules may vary based on the municipality where the inspection is being scheduled. In a non-limiting example, 16 municipalities in a city were evaluated using the developed framework and AI model. The municipalities are: ‘Municipality A’, “Municipality B’, “Municipality C’, “Municipality D’, “Municipality E’, “‘Municipality F”, “Municipality G’, “Municipality H’, “Municipality I’, “‘Municipality J”, “Municipality K’, “Municipality L’, ‘Uraija’, ‘Shemesy’, ‘Irqa’, ‘Haier.’

License data 102, visit data 103, violation data 104, inspector data 105, and neighborhood data 106 may be matched in sub-processes of the filtering and processing module 108 to prepare and scrub the data for the different models depicted in FIG. 1.

The filtering and processing module 108 may filter and/or process the different types of visits and violations, match the names of the neighborhoods, and evaluate the inspector to neighborhood relation. The output of the filtering and processing module 108 may be input to the different types of models. Data and model hyperparameters optimization may take place iteratively until the probability of finding violations achieves maximum accuracy.

The models used by the inspection scheduling system 100 to schedule an inspection may include an establishment model 110, an inspector model 112, and a violation model 114.

The inspector model 112 may generate inspector information from inspector features extracted from the output of the filtering and processing module 108. For example, the inspector features may include the inspector's name, visit duration of the inspector, errors of the inspectors during visits, the number of error-free visits by the inspectors, the total number of violations found, name of municipality, activity type (commercial, medical, or other), and types of violation found.

The establishment model 110 generates establishment information from establishment features and penalty features extracted from the output of the filtering and processing module 108. For example, the establishment features may include municipality name, activity types of the business establishment, previous violation history, days since last violation, number of past inspections, etc. The penalty model takes as input area, days_since_last_violation, prev_violations, time_since_last_visit, num_past_inspections, owner_identity_number, license_start_days, license_end_days, municipality, category_name, activity_type as independent variables and penalty_amount as target or dependent variable.

The establishment information may include a probability score of a business's probability of having one or more violations during an inspection and whether any of such violations can lead to one or more penalties. A business establishment may be liable to pay the penalty depending on whether the violation is approved, a warning violation, an awareness violation, or a canceled violation.

The violation model 114 may generate the inspection schedule based on inspector information and the establishment information for an inspector of inspector features. The inspector information comprise any one or any combination of any two or more of days since last visit, no of violation in 3 months, and no of past inspections. In addition, the inspector features may be extracted from the output of the filtering and processing module 108.

The inspector features comprise any one or any combination of any two or more of an identity of the inspector, a number of visits the inspector is assigned to complete within a predetermined time, a number of violations issued by the inspector, a number of high-risk violations issued by the inspector, a number of medium risk violations issued by the inspector, a number of low-risk violations issued by the inspector, a number of approved violations issued by the inspector, a number of canceled violations issued by the inspector, an average duration of inspection carried out by the inspector, a number of erroneous violations issued by the inspector, and a number of clean inspections issued by the inspector.

The penalty features comprise any one or any combination of any two or more of a location of the establishment, a name of the establishment, an identity number of the establishment, a category of the establishment, an activity type of the establishment, a number of days since last violation of the establishment, a number of previous violations of the establishment, a number of past inspections of the establishment, a start date for a license of the establishment, an end date for the license of the establishment, and prior penalty history of the establishment.

The establishment features comprise any one or any combination of any two or more of a type of the establishment, a type of license needed for the establishment, a time of operation of the establishment, previous violations issued to the establishment, a number of days since a last violation of the establishment, a number of past inspections of the establishment, a number of previous violations of the establishment, a time since the last visit by the inspector to the establishment.

For example, each establishment model 110, inspector model 112, and violation model 114 may be a neural network configured to solve a problem through synaptic combinations that change the connection strengths of synapses through training.

The neural network or an artificial neural network (ANN) may generate a mapping between input patterns and output patterns and may have a generalization capability to generate a relatively correct output with respect to an input pattern that has not been used for training. The neural network may refer to a general model that can solve a problem, where nodes form the network through synaptic combinations and change the connection strength of synapses through training.

The neural network or an artificial neural network (ANN) may generate a mapping between input patterns and output patterns and may have a generalization capability to generate a relatively correct output with respect to an input pattern that has not been used for training. The neural network may refer to a general model that can solve a problem, where nodes form the network through synaptic combinations and change the connection strength of synapses through training.

The neural network may be a model with a machine learning structure designed to extract feature data from input data and to provide an inference operation based on the feature data. The feature data may be associated with a feature obtained by abstracting input data. For example, if input data is an image, feature data may be obtained by abstracting the image and represented in the form of, for example, a vector. The neural network may map input and output data in a nonlinear relationship based on deep learning to perform inference operations. Deep learning, a machine learning method used for inference operation and tasks such as speech recognition or speech transliteration from a big data set, may map input and output data to each other through supervised and/or unsupervised learning.

In an example, training an artificial neural network may indicate determining and updating weights and biases between layers or weights and biases among a plurality of nodes belonging to different layers adjacent to one another. In an example, the weights and biases of a plurality of layered structures, a plurality of layers, or nodes may be collectively referred to as connectivity of an artificial neural network. Therefore, training an artificial neural network may indicate the construction and training of the connectivity.

The neural network may be implemented as an architecture having a plurality of layers, including an input image, feature maps, and an output. In the neural network, the input image may be convoluted with a filter called weights, resulting in a plurality of feature maps. The output feature maps may be again convoluted as input feature maps with the weights, and a plurality of new feature maps may be output. After the convolution operations are repeatedly performed, the recognition results of features of the input image through the neural network may finally be output.

For example, when an image of a 24×24 pixel size is input to the neural network, the input image may be output as feature maps of 4 channels, each having a 20×20 size through a convolution operation with weights. Also, some of the pixel values of the feature maps of 4 channels, each having a 20×20 size, may be subject to a sub-sampling operation, such as, for example, max-pooling and average-pooling, to output feature maps of 4 channels, each having a 10×10 size. In an example, the 10×10 feature maps may be repeatedly subject to convolution operations and sub-sampling operations with weights so that the sizes of the 10×10 feature maps may be reduced, and global features may be output. The neural network may repeatedly perform convolution operations and sub-sampling (or pooling) operations on the several layers to filter robust features, i.e., global features that are capable of representing the input image from the input image, to output the global features, and to input the global features to the fully connected layer, thereby recognizing the input image.

In another example, the neural network may receive an input source sentence (e.g., voice entry) instead of an input image. In such an example, a convolution operation is performed on the input source sentence with a kernel, resulting in the feature maps output. The convolution operation is performed again on the output feature maps as input feature maps, with a kernel, and new feature maps are output. When the convolution operation is repeatedly performed as such, a recognition result with respect to features of the input source sentence may be output through the neural network.

The neural network may include a deep neural network (DNN). The neural network may include a convolutional neural network (CNN), a recurrent neural network (RNN), a perceptron, a multiplayer perceptron, a feed forward (FF), a radial basis network (RBF), a deep feed forward (DFF), a long short-term memory (LSTM), a gated recurrent unit (GRU), an auto encoder (AE), a variational auto encoder (VAE), a denoising auto encoder (DAE), a sparse auto encoder (SAE), a Markov chain (MC), a Hopfield network (HN), a Boltzmann machine (BM), a restricted Boltzmann machine (RBM), a deep belief network (DBN), a deep convolutional network (DCN), a deconvolutional network (DN), a deep convolutional inverse graphics network (DCIGN), a generative adversarial network (GAN), a liquid state machine (LSM), an extreme training machine (ELM), an echo state network (ESN), a deep residual network (DRN), a differentiable neural computer (DNC), a neural turning machine (NTM), a capsule network (CN), a Kohonen network (KN), and an attention network (AN).

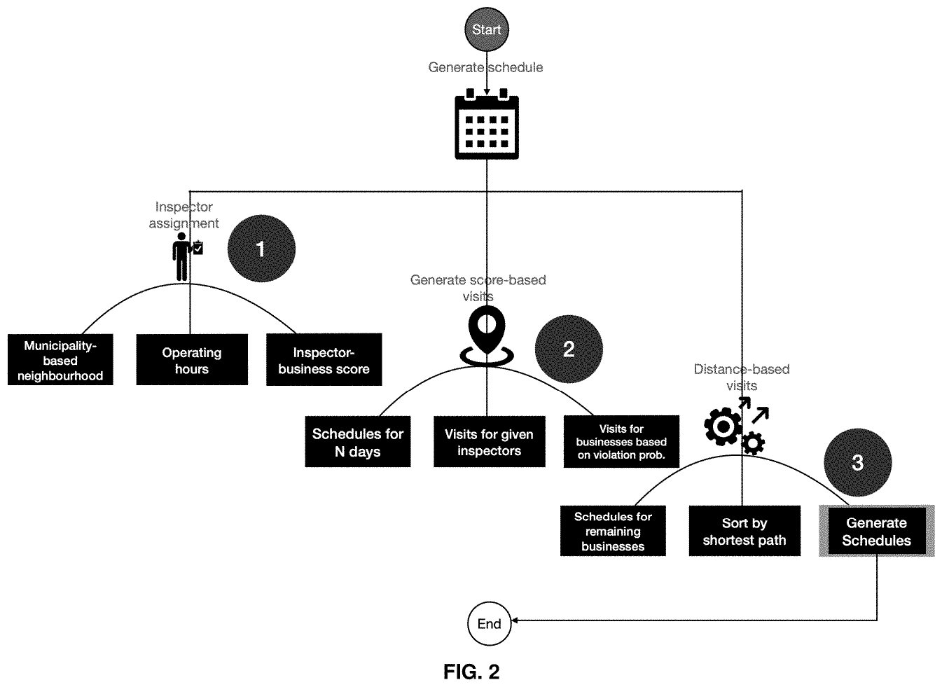

FIG. 2 illustrates an example of scheduling generation process flow 200 depicting various stages and sub-processes capturing various features in the dataset before an inspection schedule is generated. The scheduling generation method may automatically assign daily inspection schedules to the most relevant inspectors. FIG. 2 describes the entire schedule generation process flow in various stages.

The scheduling generation method may automatically generate daily schedules for the inspection staff to conduct business inspections, targeting the most likely violators of business rules. The scheduling generation method may generate an inspection schedule based on the inspector's assignment, score-based visits, and distance-based visits. The inspector's assignment may be based on the municipality, the operating hours of the businesses, and the inspector's business score. The score-based visits may be based on the schedules for N number of days, visits for giving inspectors, and visits for businesses based on violation probability. The distance-based visits may be based on schedules for remaining businesses, sorting by shortest path, and generation of schedules.

The Intelligent Scheduling system 100 may be used by any regulatory authority that needs to run inspection rotations to monitor compliance. In certain cases, it may not be possible to visit all locations; hence there may be a desire to select locations that require close monitoring regarding regulatory compliance. Some examples of regulators where Intelligent Scheduling system 100 may be used are (a) city municipalities to monitor retail stores, such as restaurants, grocery stores, commercial shops, barbers, and fitness centers; (b) the Ministry of Labor to monitor compliance to labor laws and regulations, and (c) Food and Drug Authority that regulate drugs, supplied by pharmaceuticals to pharmacies and healthcare businesses, for public consumption.

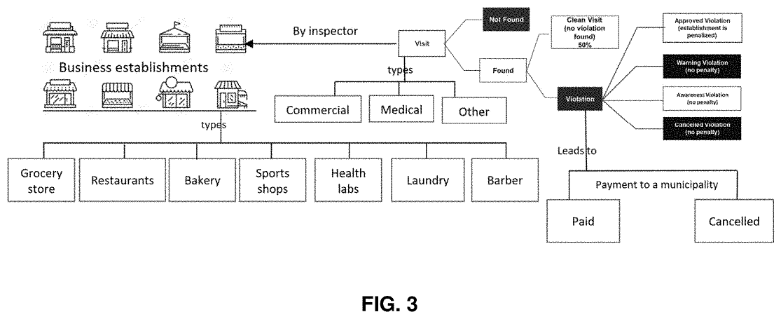

FIG. 3 illustrates an example of building blocks of an inspection, including types of business establishments, inspection visits, visit types, violations, and payment to a municipality for a confirmed violation.

The intelligent scheduling method and apparatus provide intelligent scheduling capabilities to a city municipality organization, where they depend on scheduling inspections of business establishments to ensure compliance with government regulations. The government regulations may relate to business operation licenses, hygiene standards, storage and maintenance of perishable products, healthcare delivery, etc. To conduct inspections, the city municipality organization may rely on field inspectors tasked with carrying out daily inspection visits in certain parts of the cities, falling under different geographical jurisdictions of the city municipalities. Each visit can lead to many possible outcomes, such as (a) violation of non-compliance may be found, and penalty issued (approved violation), (b) partial violation of non-compliance may be found, and a warning may be issued (pending the violation), (c) an inspection visit may be canceled because the business doesn't operate during certain times of the day (canceled violation), (d) an inspection visit may be guesstimated to be compliant and hence declared fit-for-purpose without a visit, and (e) an inspection visit may be undertaken without due-diligence and declared compliant while, it should have been non-compliant (false-negative and false positive scenario).

In all of the above scenarios, the inspection visit incurred a cost, e.g., inspection time and resources spent (fuel and logistic supplies, etc.). Therefore, to optimize the entire life cycle of the inspection process, we propose an optimal and cost-effective intelligent inspection system 100, configured to account for all aspects of the inspection process, such as, for example, visit, inspection, business establishment types, business hours, geographical constraints, and appropriate assignment of inspectors to a specific type of business as illustrated in FIG. 3.

Inspection visits may be of three types: (1) scheduled visits, (2) unscheduled visits or emergency visits, and (3) manually assigned visits for an enforcement campaign. Emergency and manually assigned visits are usually arranged by the municipality administration, where inspection visits are set up targeting some locations in the city with a high probability of committing violations.

Manual generation of daily inspection schedules is time-consuming, error-prone, and devoid of priority-based inspection of business establishments. The cost of a single inspection increases manifold when many inspections are undertaken without considering the business attributes and inspectoral historical visit data. The problem may be further complicated when the business type ‘dimension’ is included in the overall ecosystem of regulatory inspection. Table 1 summarizes examples of business types that may require regular inspection to ensure they comply with the local government's regulation.

Activity Type

restaurants
grocery stores
bakeries
butchers & fish markets
coffee shop
barber
commercial services
Factories
unknown
workshops
automotive services/gas stations
construction material

Utilizing state-of-the-art emerging AI technologies for automating inspection scheduling (with AI optimization in mind) makes a significant difference in resource optimization and conservation.

The Method and Apparatus for Artificial Intelligence-Based Intelligent Inspection Scheduling innovate the overall priority-based business inspection visits generation and performance-based inspection optimization, which results in time and resource optimization for the municipal authorities.

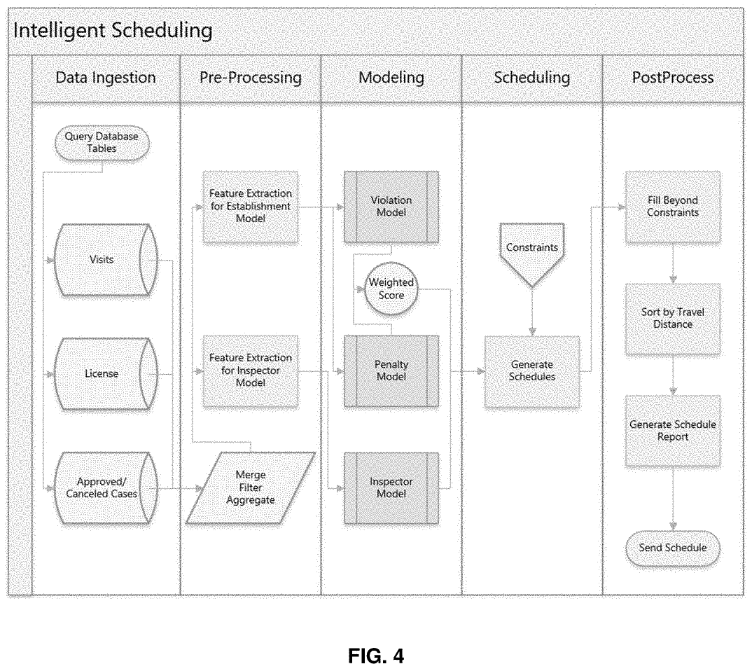

FIG. 4 illustrates an example of artifacts of the intelligent inspection scheduling process 400, including data ingestion process 402, pre-processing process 404, modeling process 406, scheduling process 408, and post-process stage 410. FIG. 4 illustrates an example of the building blocks of the intelligent scheduling system 100, which may start with the data ingestion process 402, where relevant data may be acquired from an original data source and may get passed on to the pre-processing process 404 stage, where sub processing may take place including feature extraction for business establishment and inspectors.

The optimization modeling may be performed in the modeling process 406 phase, where inferences by the violation model, penalty model, and the inspector model take place, based on the features extracted from the pre-processing process 404 stage. For example, the violation model may then assign weight to the likelihood of committing violations by a set of businesses, along with a score assigned to specific inspectors based on the optimized score from the inspector model for inspection.

The scheduling process 408 may generate schedules based on constraints for features generated by the modeling process 406.

A post-process stage 410 may sort the schedule based on distance and generate a schedule report.

The penalty model may determine the probability of whether a penalty can be imposed based on the potential and gravity of violation by a specific business establishment. In an example, the penalty model may take as input area, days_since_last_violation, prev_violations, time_since_last_visit, num_past_inspections, owner_identity_number, license_start_days, license_end_days, municipality, category_name, activity_type as independent variables and penalty_amount as target or dependent variable.

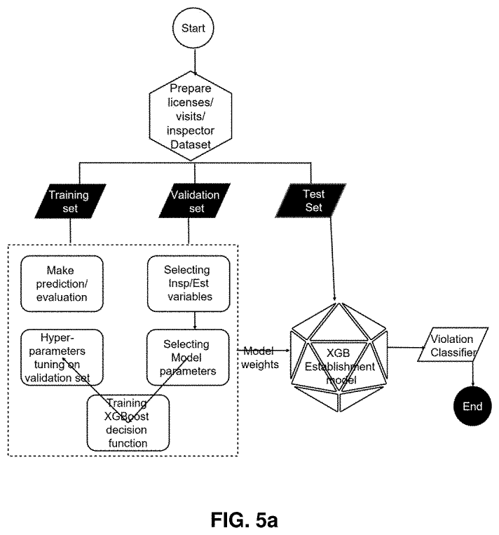

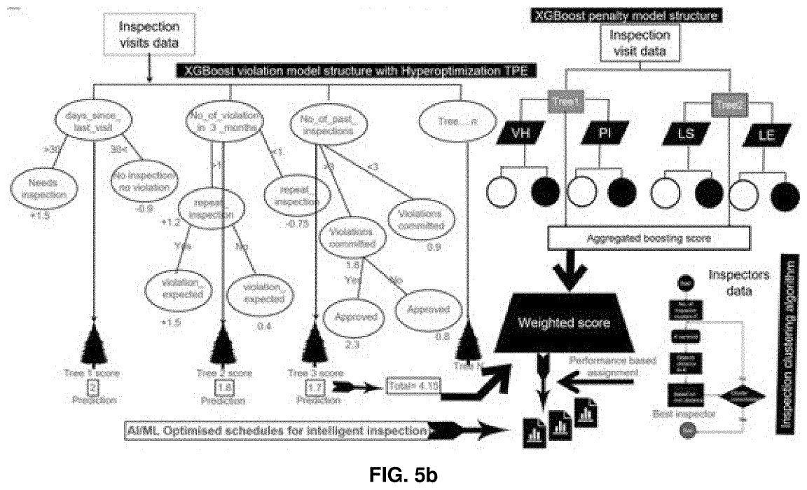

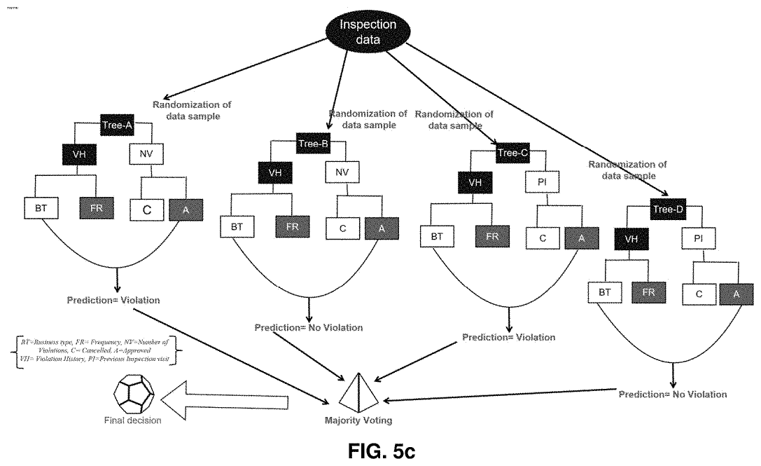

FIG. 5a illustrates an example of a configuration of a gradient boosting model 500 for finding/classifying business violations, such as, for example, XGBoost gradient boosting model. The illustrative examples described are not limited to the XGBoost gradient boosting model, and other gradient boosting models such as, for example, AdaBoost, CatBoost, and LightGBM may be used without deviating from the spirit and scope of the illustrative examples described.

As shown in FIG. 5a, the establishment model 110 takes features input from the filtering and processing module 108 to generate a weighted score for penalty and violation probabilities. Examples of feature inputs to the establishment model 110 may include municipality name, activity type, days since last violation, previous violation, number of past inspections, times since last inspection visit, etc. Structural blocks of the establishment model 110 may include but are not limited to: data acquisition, preparation of data (visits, licenses, inspectors), splitting data into training and testing for feeding into the AI ensemble model, such as a gradient boosting machine learning model and using the model weights to predict the probability of finding and classifying violation against a particular business.

5b illustrates an example of a supervisor ML XGBoost gradient descent model architecture and weighted score computation. In FIG. 5b, LS stands for license start, LE for license end, VH for violation history, and PI for previous inspection.

Gradient boosting is a training technique on decision trees. Instead of a single decision tree, or random forest, new trees are added iteratively until no further improvement is made. This assembling technique and regularisation are critical in preventing overfitting, which means the algorithm won't fit accurately on new data (low accuracy and false positive). Although the model could be very powerful, many hyperparameters can be fine-tuned. We have specifically used TPE Hyperparameters with the XGBoost algorithm to optimize the combined score required for generating an intelligent inspection schedule.

Boosting works on improving the mistakes of the previous learner through the next learner. In boosting, weak learners are used, which perform only slightly better than a random chance. Boosting focuses on sequentially adding up these weak learners and filtering out the correct observations that a learner gets at every step. The stress is on developing new weak learners to handle the remaining difficult observations at each step.

In gradient-boosting decision trees, we combine many weak learners to create one strong learner. The weak learners here are the individual decision trees. All the trees are connected in series, and each tree tries to minimize the error of the previous tree. Due to this sequential connection, boosting algorithms are usually slow to learn but also highly accurate.

The weak learners fit in such a way that each new learner fits into the residuals of the previous step as the model improves. The final model aggregates the result of each step, and thus a strong learner is achieved.

XGBoost uses decision trees. Instead of training just one large decision tree, XGBoost and other related algorithms train many small decision trees. The intuition behind this is that even though single decision trees can be inaccurate and suffer from high variance, combining the output of a large number of these weak learners can lead to a strong learner, resulting in better predictions and less variance. Boosting algorithms start with a single small decision tree and evaluate how well it predicts the given examples. When building the next tree, those samples that have been misclassified before have a higher chance of being used to generate the tree, which may be useful because it avoids overfitting to samples that can be easily classified and instead try to come up with models that can classify hard examples, too.

Gradient boosted trees use regression trees (or CART) as weak learners in a sequential learning process. These regression trees are similar to decision trees; however, they use a continuous score assigned to each leaf (i.e., the last node once the tree has finished growing) which is summed up and provides the final prediction. For each iteration i, which grows a tree t, scores w are calculated, which predict a certain outcome y. The learning process aims to minimize the overall score, composed of the loss function at i−1 and the new tree structure of t, which allows the algorithm to grow the trees and learn from previous iterations sequentially. Gradient descent is then used to compute the optimal values for each leaf and the overall score of tree t. The score is also called the impurity of the predictions of a tree.

The combined (aggregated) weighted score may be represented by

$$Combined weighted score = {\sum }_{i = 1}^{N} ( \frac{( r - {r}_{min} )}{{r}_{max} - {r}_{min}} * γ ) + {V}_{p}$$

FIG. 5c illustrates an example of an XGBoost with TPE (Tree-structured Parzen Estimator) demonstrating the main tree node, interior (1^{st} level nodes), and leaves (last nodes). BT represents the business type, FR represents the frequency, NV represents the number of violations, C represents cancelled, and A represents approved, VH represents violation history, and PI represents previous inspection visit.

While FIG. 5c references the violation probability computation, the architecture may be equally applied to the penalty model where the penalty amount for various business establishments is predicted using the XGBoost gradient boosting algorithm.

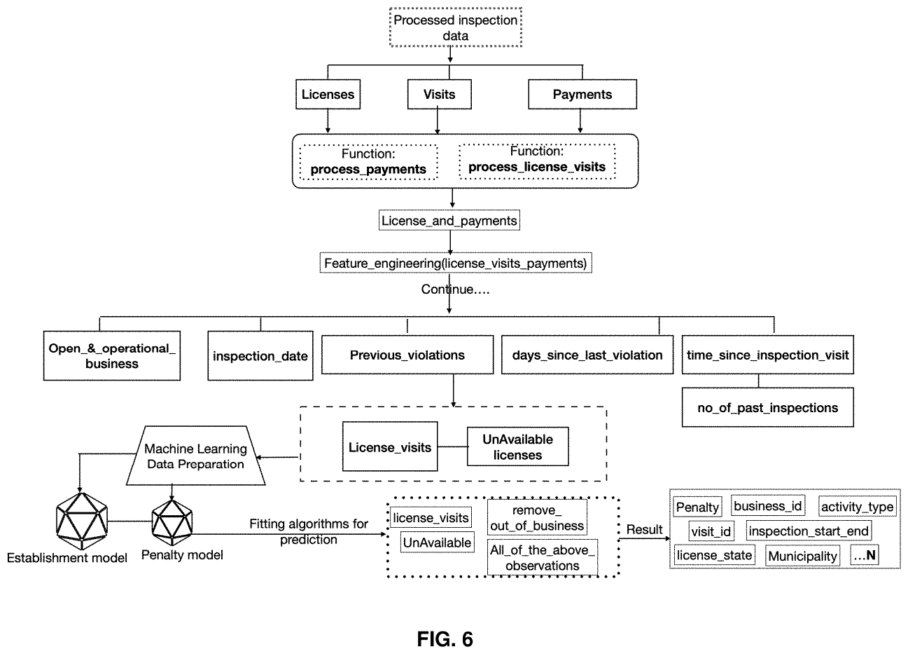

FIG. 6 illustrates an example of a configuration of gradient boosting model for computing the probability of finding violations for business establishments.

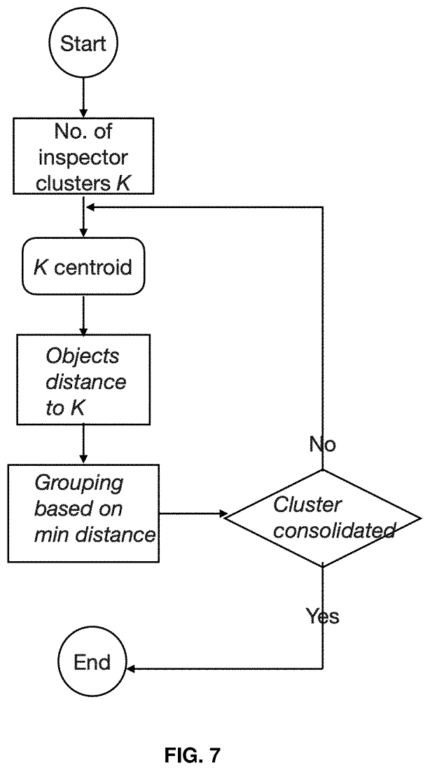

FIG. 7 illustrates an example of a KMeans cluster for inspector performance score classification. FIG. 7 is an example of performance-based clustering that may be used for inspector performance classification before they are assigned with a business based on their suitability, previous inspection performance, and track record of finding violations.

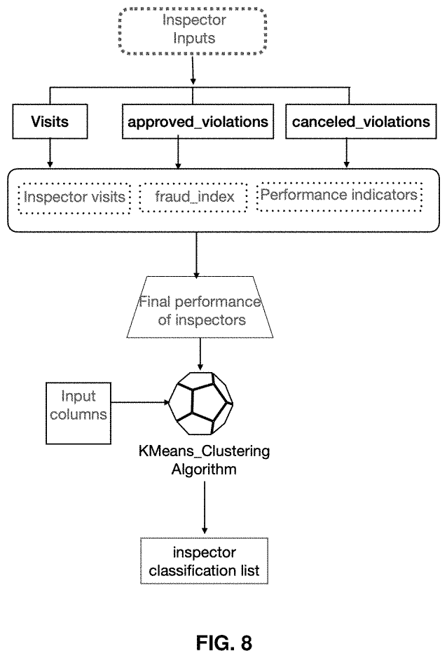

FIG. 8 illustrates an example of an inspector performance clustering model to distribute inspectors in a performance-based cluster for an inspection assignment.

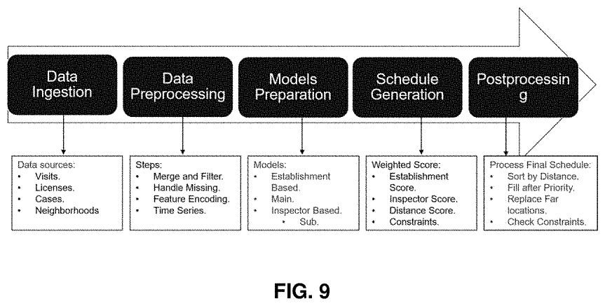

FIG. 9 illustrates an example of data acquisition, ingestion, pre-processing, model preparation, and optimization for schedule generation and post-processing. FIG. 9 illustrates an example of the overall data acquisition and processing process before the data may be provided to the ML models. The establishment and inspector models output an aggregated weighted score comprising establishment, inspector, distance, and constraints.

Data pre-processing involves multiple steps, including, but not limited to, removing invalid violations. Invalid violations may be of two types: (1) canceled violations which a business establishment may receive from an inspector, but it aims to give a warning before a proper violation with a penalty is served, and (2) invalid violation is a violation which was not properly decided due to discrepancies in the inspection process.

For example, the total number of violations per business may be computed after removing the second type of violation, i.e., invalid violations. The penalty amount may be calculated based on the proper or approved violations and canceled/warning violations excluding the invalid ones.

In an example, the license dataset preparation may include processing the inspection neighborhood names to match them with the names in the visit dataset. In an example, the duplicate data entries may be removed with the last entry remaining as the only observation data point.

In an example, the visits and licenses may be merged. In an example, the license table may contain information on the business establishment and the Visit, and records information on the inspector visit, including the time of the visit, inspector, previous visit, etc. In order to enrich the visits with data about the business establishment, in an example, the tables may be merged using the unique business establishment id.

The final post-processing may be performed by applying the sorting of establishments based on distance, prioritization score, and constraints score generated in the preceding step at the time of schedule generation.

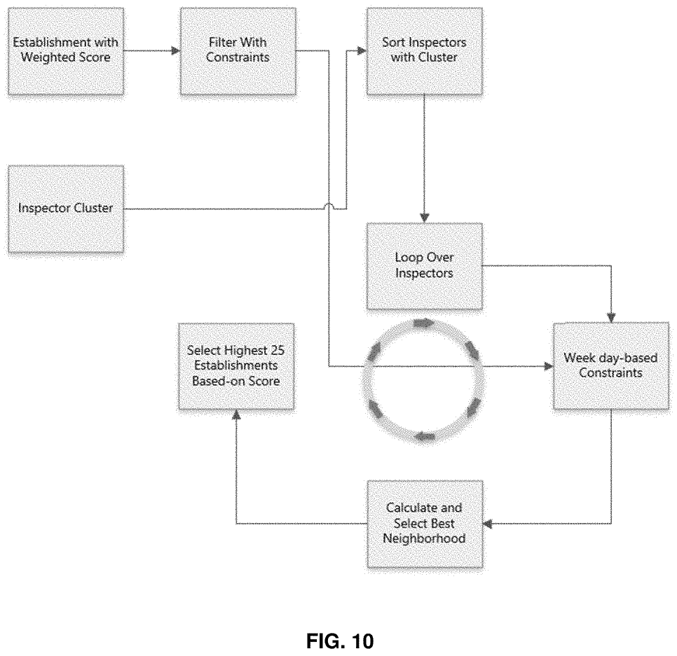

FIG. 10 illustrates an example of establishment and inspector models with constraints for selecting inspectable establishments. For example, the AI-based inspection scheduling method and apparatus may combine the establishment, the inspector, and penalty models to build a violation finder, inspector performance indicator, and penalty issuance pipeline. The stage-wise data pre-processing, algorithm fittings, and combining the two leads us to generate an AI-optimization-based inspection schedule, leading to better resource utilization on the ground by accurately targeting violation-committing businesses. The precision in the optimal utilization of inspectoral resources to identify violating businesses leads to fast compliance with the municipality's regulations and correct and prompt penalty issuance for violation. The precision in penalty issuance and payment of the fine by the businesses further helps the local councils and municipalities recover the return on investment (investment in AI and emerging technologies, for example) in the form of revenues from the penalties. Thus, leading to a better compliance rate in the city, better public service, and improved well-being of the public living in the city.

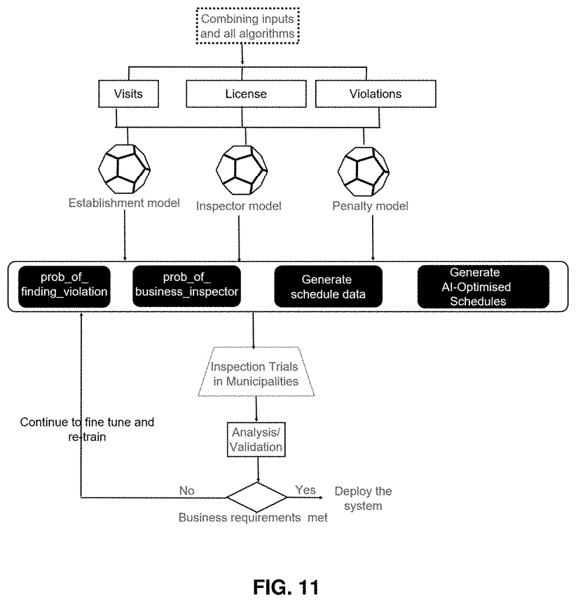

FIG. 11 illustrates an example of a combination of visits, licenses, and penalty payments to fine-tune the final predictive outcomes vis-à-vis business requirements through municipality trials.

One of the components in FIG. 8 may be the constraints uncounted during the intelligent scheduling generation using AI &ML inspection and violation models. For example, intelligent schedule generation determines a business establishment index sorted by the probability of finding a violation. The constraints affect that outcome in various ways, such as assigning an inspector to a business due to time and operational constraints. In an example, various other factors may be considered, such as, for example, business to business assignments, the operations of the business, license status of the business, etc., while assigning schedules to inspectors. Further constraints may include but are not limited to: (1) variation inspector performance based on neighborhood assignment . . . greedy over 25 neighborhood assignment for inspectors . . . vs. greedy max neighborhood assignment . . . ; (2) Neighborhood related limitations . . . initial assignment of inspectors improved probability of having correct neighborhoods . . . (3) business operation hours, etc.

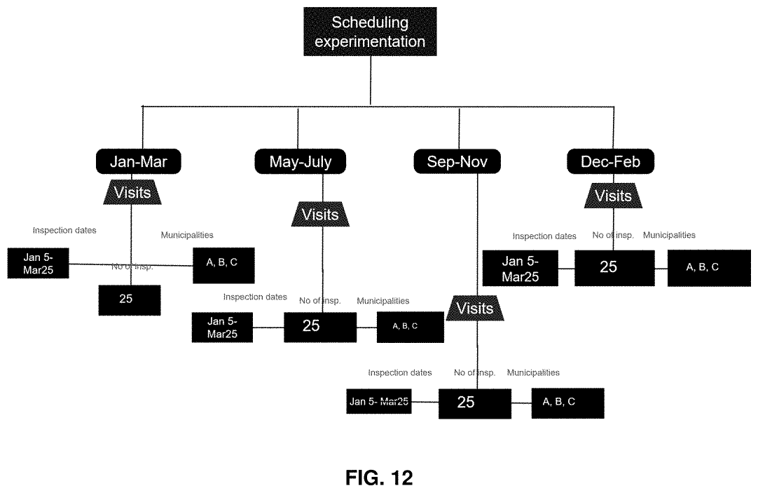

FIG. 12 illustrates an example of conducting trials for the municipalities-based intelligent scheduling validation. FIG. 12 draws on the number of experiments and trials conducted to test the system in a real-time inspection environment. In total, 4 trials were conducted in collaboration with the actual client, and the summary of trials and outcomes from these trials are described below. Daily schedules were generated using establishment model 110 and inspection model 112. The following criteria were used to analyze the accuracy and functional performance of the apparatus and methods disclosed above:
Compare visits that comply with our schedules (i.e., intelligent scheduling vs. manual scheduling) against the visits that don't comply with the schedule.
Compare before and after performance of the system across the 3 municipalities: mA, mB, mC
Compare municipalities on trial with non-trialed municipalities
Use performance metrics to validate the accuracy and precision of the algorithm using:
1. Percentage of inspection visits led to a violation
2. Average penalty for violation per visit

### Performance Evaluation Trial: Compliance Rate

| | Compliance |
|---|---|
| Municipality | Rate |
| mA | 73.31% |
| mB | 60.33% |
| mC | 74.61% |
| Overall | 67.57% |

### Inspection Visit Types

| | | | Manually |
|---|---|---|---|
| | Unscheduled | Scheduled | Assigned |
| Visits to est. without | 98.85% | 1.09% | 0.05% |
| a license | | | |
| Emergency Visits | 99.81% | 0% | 0.19% |

After the second trial, the system was upgraded to consider the location of the shops and the opening and closing hours. This trial was smoother than the second trial, there was more compliance, and there was a performance improvement (percentage of visits with violations); however, there were still complaints about scheduled visits to establishments that have already been visited. The percentage of non-compliant visits was still too relatively high, and it was difficult to highlight the improvement after using the intelligent scheduling system.

### Inspection Visit Compliance Criteria

We used different metrics to measure the compliance rate in the 3 municipalities to evaluate the system performance against the manual inspection visits.

Percentage of Visits with Violations

$$Percentage of Visits with Violations = \frac{num of visits with compliant viols}{num of compliant visits}$$

Average Penalties for violation

$$Average Penalties = \frac{sum of compliant visit penalties}{num of compliant visits}$$

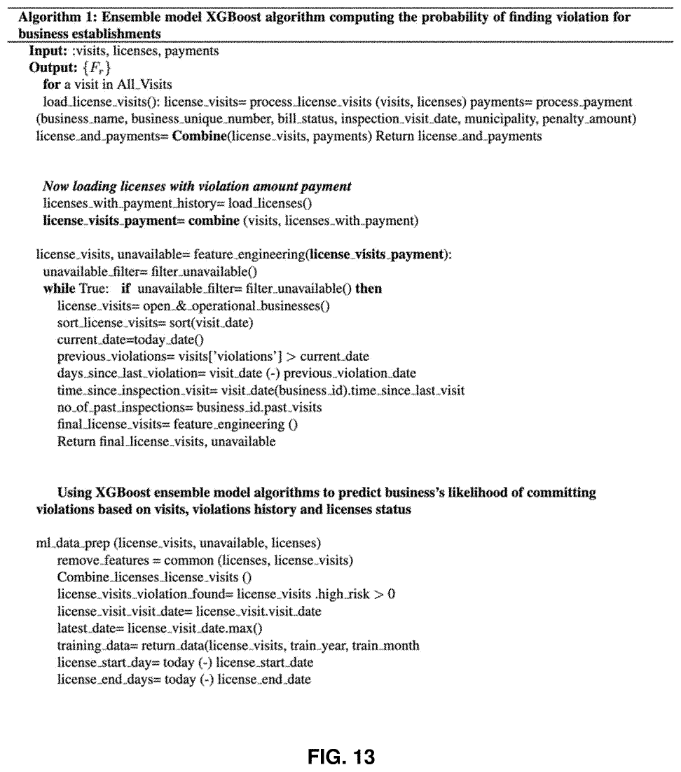

FIG. 13 illustrates an example of a gradient boosting model for determining the probability of finding violations for business establishments. The algorithm of FIG. 13 may be pseudocode for the establishment model 110 algorithm in which historical visits of businesses are taken as input and prediction of finding violation after the inspection of a visit as an output.

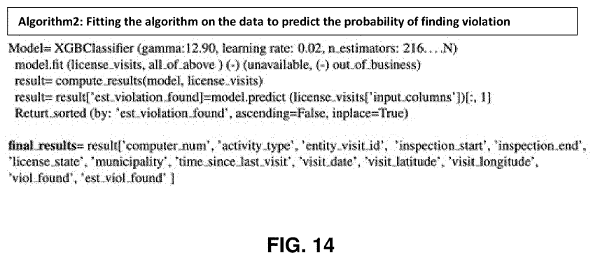

FIG. 14 illustrates an example of a gradient boosting model for determining the probability of finding violations for business establishments. An example of fitting the algorithm on the data to predict the probability of finding violations is provided by FIG. 14.

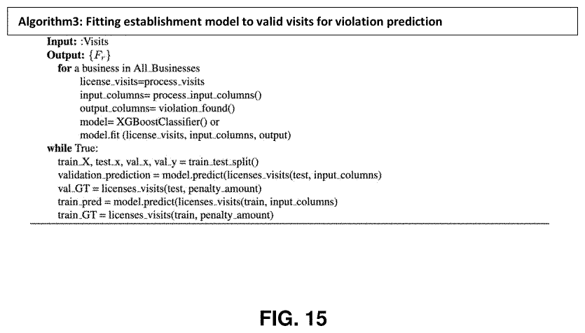

FIG. 15 illustrates an example of fitting an establishment model to valid visits for violation prediction. FIG. 15 illustrates the train/test split that may be needed for equal data distribution before fitting an AI algorithm.

The training of the models may involve the optimization of model parameters and the combinatorial arrangements to maximize the model performance with the precise data and model parameters. Optimization of model hyperparameters before running the training to control the behavior of ML models may be incorporated into the intelligent scheduling system 100.

Training may be performed using cross-validation, objective function optimization, and fine-tuning the model using various optimization algorithms before selecting the best model weights based on minimum loss and maximum accuracy.

For example, K-means algorithms may be used to optimize the aggregated inspection score. The function to be optimized may be the sum of the quadratic distance from each inspector object to its cluster centroid. In an example, all inspector objects may be represented with D dimension vectors such that D={I1, I2, I3, . . . In} and the algorithm K-means builds k groups where the sum of the distance of the objects to its centroid is minimized within each group, i.e., G={G1, G2, G3, . . . Gk} based on Equation 1 below:

$$\begin{matrix}min \\ s\end{matrix} E ( {μ}_{i} ) = \begin{matrix}min \\ s\end{matrix} {\sum }_{i = 1}^{k} {\sum }_{{I}_{j} ∈ {G}_{i}}^{n} {‖ {I}_{j} - {μ}_{i} ‖}^{2} \qquad Equation 1$$

Where S is the inspector's dataset whose elements are the objects Iⱼ represented by vectors, where each of the elements may represent a characteristic or attribute. As per Equation 1, we may have k inspector clusters with their corresponding centroid μᵢ.

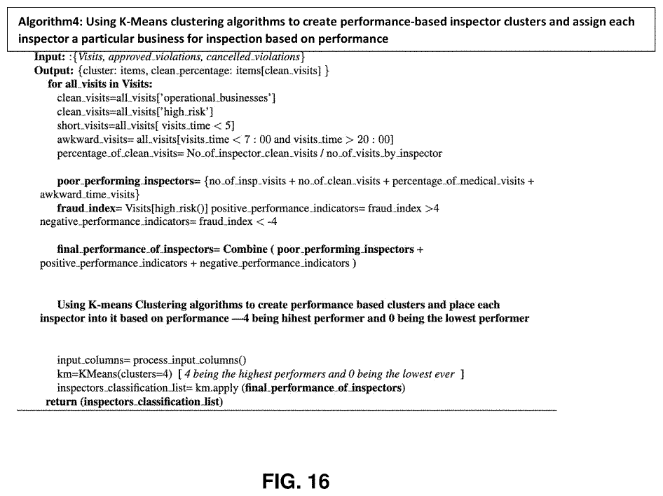

FIG. 16 illustrates an example of using K-Means clustering to create performance-based inspector clusters and assign each inspector to a particular business for inspection based on performance.

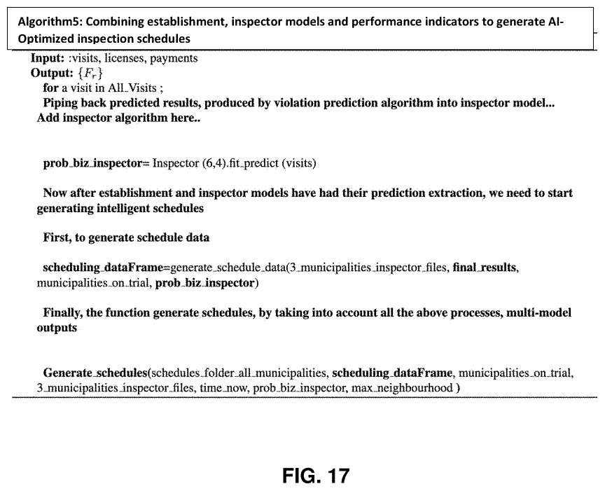

FIG. 17 illustrates an example of combining establishment and inspector models to performance indicators to generate optimized inspection schedules.

The algorithm illustrated in FIG. 17 combines the preceding algorithms' results and generates schedules intended for the appropriate inspectors. In an example, the appropriate inspector is determined based on their performance indicators produced by the inspector algorithm to target the right businesses (based on their previous violation history, business types, etc.), thus leading to a penalty amount being issued with the least possible resource consumed. In an example, the scheduling data is first generated using the 3 municipalities to validate the efficiency and precision of the AI models.

For example, the max_neighborhood parameter may be applied to the function above (Generate_schedules) to determine the correct assignment of an establishment to the appropriate inspector to maximize the chances of detecting violations. For example, Max_neighborhood may utilize a haversine algorithm for finding the shortest path between the municipality neighborhood and the available inspector to assign the inspector based on his/her performance indicators and the distance from home to inspectable business.

The application of both optimal_distance and neighborhood_constraints functions is described in detail below as they are applicable to the tuning of the inspector and establishment models.

The max_neighborhood parameter may be applied to the function (Generate_schedules) to obtain the correct assignment of an establishment to the appropriate inspector to maximize the chances of finding a violation. Max_neighborhood utilizes adjacency-matrix-based optimal distance computation function. The computation aims at finding the shortest path between the municipality neighborhood and the available inspector to assign the inspector based on his/her performance indicators and distance from the inspector's home base to the inspectable business. The optimal_distance and neighborhood_constraints functions may be used in the Max_neighborhood algorithm as these parameters influence the assignment of an inspector to an establishment based on the shortest possible distance. The adjacent matrix-based neighborhood distance assignment algorithm computes the optimal distance for each inspector who visits establishments having a maximum probability of committing violations. In an example, the inspector classification may be conducted beforehand to generate the inspector-establishment matching score.

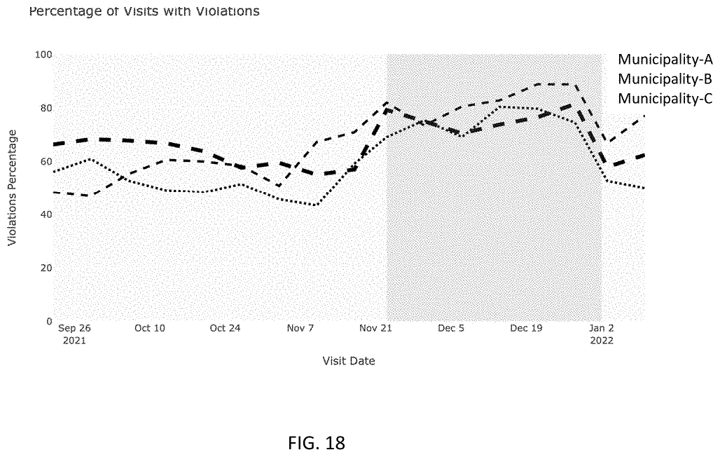

FIG. 18 illustrates a comparison between trial and non-trial municipalities. FIG. 18 depicts a percentage of penalties per trialed municipality with a trajectory of the trend line going upward, which indicates a consistent improvement in the establishment's inspection having a likelihood of violation.

TABLE 2

| | |
|---|---|
| Pre-Trial | Trial-Compliant |

| | | | |
|---|---|---|---|
| mA | 62.45% | 76.04% | (+13.59%) |
| mB | 57.58% | 82.71% | (+25.13%) |
| mC | 51.86% | 74.69% | (+22.83%) |
| aggregate | 59.04% | 78.41% | (+19.37%) |

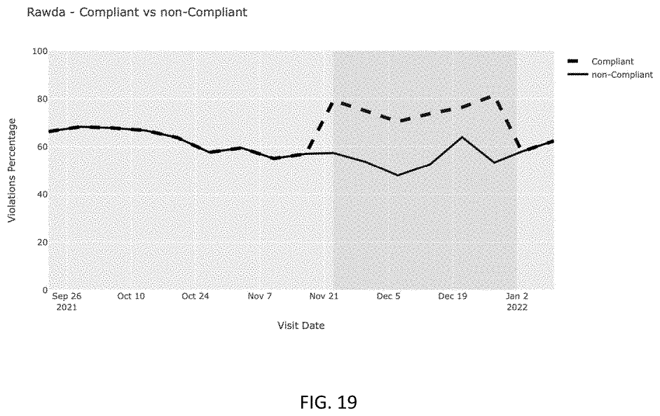

Table 2: Percentage of visits with a violation in untrialed municipality (model performance estimation). FIG. 19 illustrates a comparison between compliant and non-compliant visits.

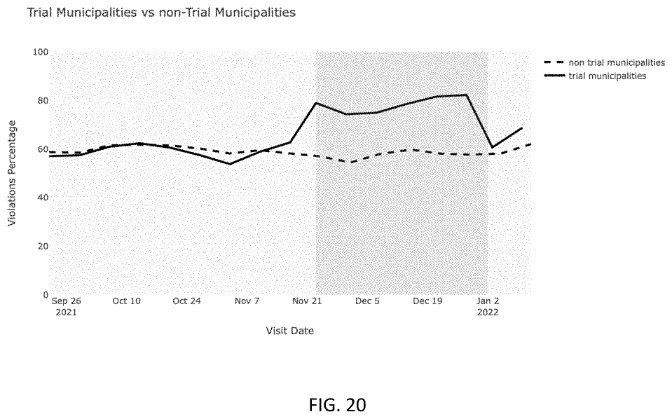

FIG. 20 illustrates a comparison between trial and non-trial municipalities.

TABLE 3

| | | Average |
|---|---|---|
| Metric | Comparison | Improvement |
| Across timeline | Pre-trial vs trial | +19% |
| | trial vs post-trial | −14% |
| | | (Performance |
| | | decreased |
| | | after trial) |
| Within trial period | Compliant vs nonCompliant | +18% |
| Comparison with other | mA vs mD | +23% |
| municipalities | mB vs mE | |
| | mC vs mF | |
| All trial municipalities | Trial municipalities | +21% |
| vs all non-trial | vs all other municipalities | |
| municipalities | | |

Table 3 illustrates the percentages of visits with confirmed violations using the inspection scheduling system 100.

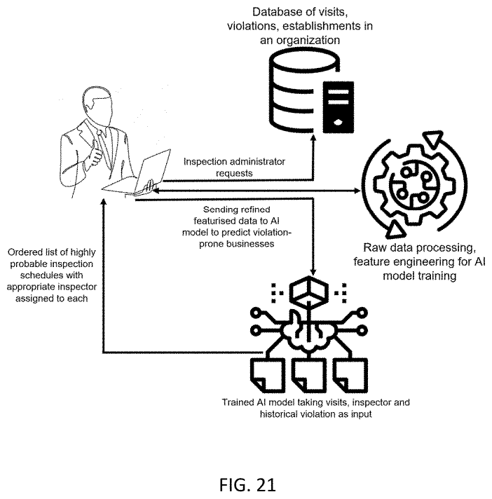

FIG. 21 illustrates an example of a user requesting an inspection schedule. In one embodiment, a user, e.g., inspection administrator, request an inspection schedule by querying a database for inspection information that may include license data 102, visit data 103, violation data 104, inspector data 105, and neighborhood data 106. The query is processed using AI models that were trained using raw data, including data to predict violation prone businesses. The user query returns an ordered list of highly probable inspection schedules with an appropriate inspector assigned to each inspection schedule. In an example, the appropriate inspector may be based on previous history, e.g., successes, of the inspector.

Regulators often run inspection rotations to ensure compliance with regulations in various sectors, such as restaurants, grocery stores, retail stores, barber shops, and fitness centers. Regulators operate under limited capacity; however, they need to target potentially non-compliant establishments to raise awareness and detect violations that jeopardize the health and well-being of citizens.

The typical scheduling system results in many inspection visits missing out on non-compliant establishments. Therefore, a large percentage of visits (more than 50%) do not detect violations (clean visits), and non-compliant establishments remain uninspected.

The methods and apparatuses described above generate schedules to prioritize the establishments with the highest probability of being non-compliant. That also optimizes the available inspection resources (inspectors, rotation visits) and ensures their sufficiency for most non-compliant establishments in a given time period.

The methods and apparatuses described above also provide a novel trained and deployed ML method for estimating the probability of non-compliance based on categorical features of a given business establishment, e.g., geographical and historical data, type of business, assigned inspectors, number of past inspections, etc.

The methods and apparatuses described above also provide a trained and deployed ML method for estimating the probability of non-compliance/fit-for-purpose assessment of municipality inspectors, based on the history of visits, neighborhood visited, violations found, violations not found, and time of visit, etc.

The methods and apparatuses described above also provide a trained and deployed penalty awarding model that considers penalty-per-visit and penalty-per-violation data observations.

The methods and apparatuses described above also provide a systematic approach to targeting non-compliant establishments using ML with optimization of scheduling constraints ranging from operational hours, and types of business to neighborhood borders constraints.

The methods and apparatuses described above also provide a trained facilitates detection of violations in real-time with low false alarms in order to mobilize available human and monetary resources at the right place and time, leading to optimized municipality performance.

The methods and apparatuses described above also replace the old system, which takes too long to go through a range of available establishments and their sub-features (in iteration) before computing a probability score. The proposed methods and apparatuses implement inspector scoring based on the inspector's performance and the establishment's historical data attributes

Compliance with regulations and violation patterns are dynamic and keeps changing constantly, and the AI-Optimization-based scheduling apparatus is agile enough to fulfill the changing needs of the inspection process.

In one general aspect, a machine learning-based (“ML”) model is provided to optimize resource usage and maximize the revenue for the local government. The AI-based system targets non-compliant businesses and optimizes the municipality's inspectors' resources for maximum revenue collection. The intelligent scheduling system may use Machine Learning algorithms to estimate the probability of non-compliance based on any one or any combination of historical, geographical, and categorical features of a business establishment.

An ML model is provided to estimate the probability of non-compliance based on a given business establishment's historical, geographical, and categorical features.

An ML model is provided to estimate the probability of non-compliance based on historical, geographical, and categorical features of a business establishment and an inspector who conducts the inspection.

A scheduling apparatus is provided for intelligently assigning inspections to each inspector based on the inspector's historical inspectoral attributes.

Non-compliance score computation and their assignment to business establishments may be provided in descending order as a priority-based inspection system to optimize resource usage.

A scheduling apparatus is provided for inspection assignment to inspectors based on geographical spread, business operating hours, neighborhood constraints, and business types.

A scheduling apparatus is provided with an iterative greedy approach to construct and assign a set of businesses (with higher non-compliance likelihood) to an inspector on a certain day from the total number of inspections on that day. The iteration may be terminated when an inspector yields a maximum score corresponding to a particular business. The business may be added to the daily list of inspections before the next iteration for the remaining businesses and inspectors.

A scheduling apparatus is provided to create constraint-adaptable and distance-optimal visits for inspectors using the inspectoral attributes.

Assignment of the inspections, non-compliant to the constraints may be performed in-between the two inspections with a minimum-possible distance where the constraints are satisfied.

The system uses ML algorithms to assign a set of inspections to each inspector, taking care of the distance covered by that inspector while conducting various visits in a neighborhood along with other constraints.

In another general aspect, an ML method is provided for an intelligent inspection system, which automatically generates weekly/daily inspection schedules. The schedules are generated listing the business establishments based on priority scoring criteria along with a respective inspector, assigned specifically for that inspection.

As a non-exhaustive example only, the electronic device and the apparatus for generating an inspection schedule as described herein may be a mobile device, such as a cellular phone, a smart phone, a wearable smart device (such as a ring, a watch, a pair of glasses, a bracelet, an ankle bracelet, a belt, a necklace, an earring, a headband, a helmet, or a device embedded in clothing), a portable personal computer (PC) (such as a laptop, a notebook, a subnotebook, a netbook, or an ultra-mobile PC (UMPC), a tablet PC (tablet), a phablet, a personal digital assistant (PDA), a digital camera, a portable game console, an MP3 player, a portable/personal multimedia player (PMP), a handheld e-book, a global positioning system (GPS) navigation device, or a sensor, or a stationary device, such as a desktop PC, a high-definition television (HDTV), a DVD player, a Blu-ray player, a set-top box, or a home appliance, or any other mobile or stationary device configured to perform wireless or network communication. In one example, a wearable device is a device that is designed to be mountable directly on the body of the user, such as a pair of glasses or a bracelet. In another example, a wearable device is any device that is mounted on the body of the user using an attaching device, such as a smart phone or a tablet attached to the arm of a user using an armband, or hung around the neck of the user using a lanyard.

The inspection scheduling system 100, and apparatus for generating an inspection schedule FIGS. 1-21 that perform the operations described in this application are implemented by hardware components configured to perform the operations described in this application that are performed by the hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-21 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An apparatus for generating an inspection schedule, the apparatus comprising:
one or more processors configured to:
receive one or more schedule requests comprising inspector features, establishment features, and penalty features;
generate inspector information for an inspector model based on the inspector features;
generate establishment information, comprising a probability of imposing a penalty on an establishment of the establishment features, for an establishment model based on the establishment features and the penalty features; and
generate, for an inspector of the inspector features using a violation model, the inspection schedule based on the inspector information and the establishment information.

2. The apparatus of claim 1, further comprising a memory configured to store instructions;
wherein the one or more processors are further configured to execute the instructions to configure the one or more processors to generate the inspector information, the establishment information, and the inspection schedule.

3. The apparatus of claim 1, wherein the inspector features comprise any one or any combination of any two or more of an identity of the inspector, a number of visits the inspector is assigned to complete within a predetermined time, a number of violations issued by the inspector, a number of high risk violations issued by the inspector, a number of medium risk violations issued by the inspector, a number of low risk violations issued by the inspector, a number of approved violations issued by the inspector, a number of cancelled violations issued by the inspector, an average duration of inspection carried out by the inspector, a number of erroneous violations issued by the inspector, and a number of clean inspections issued by the inspector.

4. The apparatus of claim 1, wherein the penalty features comprise any one or any combination of any two or more of a location of the establishment, a name of the establishment, an identity number of the establishment, a category of the establishment, an activity type of the establishment, a number of days since last violation of the establishment, a number of previous violations of the establishment, a number of past inspections of the establishment, a start date for a license of the establishment, an end date for the license of the establishment, and prior penalty history of the establishment.

5. The apparatus of claim 1, wherein the establishment features comprise any one or any combination of any two or more of a type of the establishment, a type of license needed for the establishment, a time of operation of the establishment, previous violations issued to the establishment, a number of days since a last violation of the establishment, a number of past inspections of the establishment, a number of previous violations of the establishment, a time since last visit by the inspector to the establishment.

6. The apparatus of claim 1, wherein the inspector model is trained based on unsupervised learning.

7. The apparatus of claim 1, wherein the one or more processors are further configured to generate a probability of non-compliance of a business regulation based on any one or any combination of any two or more of historical, geographical, and categorical features of the establishment.

8. The apparatus of claim 1, wherein the one or more processors are further configured to generate the inspection schedule based on geographical spread between establishments of the establishment features, the time of operation of the establishment, neighborhood constraints of the establishment, and the type of the establishment.

9. The apparatus of claim 1, wherein the inspector information comprises an inspector classification list comprising a ranking of inspectors.

10. The apparatus of claim 1, wherein the one or more processors are further configured to generate the inspection schedule based on a weighted score computation of the violation model, and a penalty model based on the penalty features.

11. A processor-implemented method for generating an inspection schedule, the method comprising:
receiving one or more schedule requests comprising inspector features, establishment features, and penalty features;
generating inspector information for an inspector model based on the inspector features;
generating establishment information, comprising a probability of imposing a penalty on an establishment of the establishment features, for an establishment model based on the establishment features and the penalty features; and
generating, for an inspector of the inspector features using a violation model, the inspection schedule based on the inspector information and the establishment information.

12. The method of claim 11, wherein the inspector features comprise any one or any combination of any two or more of an identity of the inspector, a number of visits the inspector is assigned to complete within a predetermined time, a number of violations issued by the inspector, a number of high risk violations issued by the inspector, a number of medium risk violations issued by the inspector, a number of low risk violations issued by the inspector, a number of approved violations issued by the inspector, a number of cancelled violations issued by the inspector, an average duration of inspection carried out by the inspector, a number of erroneous violations issued by the inspector, and a number of clean inspections issued by the inspector.

13. The method of claim 11, wherein the penalty features comprise any one or any combination of any two or more of a location of the establishment, a name of the establishment, an identity number of the establishment, a category of the establishment, an activity type of the establishment, a number of days since last violation of the establishment, a number of previous violations of the establishment, a number of past inspections of the establishment, a start date for a license of the establishment, an end date for the license of the establishment, and prior penalty history of the establishment.

14. The method of claim 11, wherein the establishment features comprise any one or any combination of any two or more of a type of the establishment, a type of license needed for the establishment, a time of operation of the establishment, previous violations issued to the establishment, a number of days since a last violation of the establishment, a number of past inspections of the establishment, a number of previous violations of the establishment, a time since last visit by the inspector to the establishment.

15. The method of claim 11, wherein the inspector model is trained based on unsupervised learning.

16. The method of claim 11, further comprising generating a probability of non-compliance of a business regulation based on any one or any combination of any two or more of historical, geographical, and categorical features of the establishment.

17. The method of claim 11, further comprising generating the inspection schedule based on geographical spread between establishments of the establishment features, the time of operation of the establishment, neighborhood constraints of the establishment, and the type of the establishment.

18. The method of claim 11, wherein the inspector information comprises an inspector classification list comprising a ranking of inspectors.

19. A non-transitory computer-readable storage medium storing instructions that, when executed by one or more processors, configure the one or more processors to perform the method of claim 11.
